(19) United States
(12) Patent Application Publication
(10) Pub. No.: US 2021/0303960 A1
(43) Pub. Date: Sep. 30, 2021

(54) MICROCIRCUIT CARD

(71) Applicant: STMicroelectronics (Rousset) SAS, Rousset (FR)

(72) Inventor: Olivier ROUY, Peynier (FR)

(73) Assignee: STMicroelectronics (Rousset) SAS, Rousset (FR)

(21) Appl. No.: 17/199,641

(22) Filed: Mar. 12, 2021

(30) Foreign Application Priority Data
Mar. 27, 2020 (FR) 2003073

(51) Int. Cl. G06K 19/07

(52) U.S. Cl. CPC G06K 19/0718; G06K 19/0701; G06K 19/0723

(57) ABSTRACT

A microcircuit card includes a first (general purpose) microcontroller, a second (secure processing) microcontroller, at least one module of communication with the outside of the card, and a biometric sensor. Any communication with the outside of the card transits through the first microcontroller. Any communication between the sensor and the second microcontroller transits through the first microcontroller. Furthermore, the second microcontroller is not involved in any communication to the outside of the card.

### PRIORITY CLAIM

This application claims the priority benefit of French Application for Patent No. 2003073, filed on Mar. 27, 2020, the content of which is hereby incorporated by reference in its entirety to the maximum extent allowable by law.

### TECHNICAL FIELD

The present disclosure generally relates to electronic devices and, more specifically, to microcircuit cards.

### BACKGROUND

Many applications use microcircuit cards, for example, payment cards, transport cards, personal identification cards, etc. Among current microcircuit cards, cards equipped with a biometric sensor are particularly known. A biometric sensor typically enables to perform identity checks each time the card is used. Current microcircuit cards provided with a biometric sensor are generally complex and expensive to design and to manufacture.

There is a need to improve current microcircuit cards comprising a biometric sensor.

### SUMMARY

An embodiment overcomes all or part of the disadvantages of known microcircuit cards comprising a biometric sensor.

An embodiment provides a microcircuit card comprising: a first microcontroller; a second microcontroller; at least one module of communication with the outside of the card; and a biometric sensor. Any communication with the outside of the card transits through the first microcontroller. Any communication between the sensor and the second microcontroller transits through the first microcontroller.

According to an embodiment, the second microcontroller is a secure microcontroller.

According to an embodiment, the second microcontroller is dedicated to processing and storing secure data.

According to an embodiment, the second microcontroller has a memory capacity smaller than that of the first microcontroller.

According to an embodiment, the first microcontroller is coupled, preferably connected, to two modules of communication with the outside of the card: a first near-field communication module; and a second contact communication module.

According to an embodiment, the first microcontroller is configured to implement: a near-field communication protocol; and a contact communication protocol.

According to an embodiment, the first microcontroller comprises: a power management unit; and an operation sequencing unit.

According to an embodiment, the first microcontroller is configured to control: the second microcontroller; the communication module; and the sensor.

According to an embodiment, the first microcontroller is configured to manage an electric power supply of the second microcontroller.

According to an embodiment, the first microcontroller is configured to process data originating from the sensor.

According to an embodiment, the first microcontroller and the second microcontroller form part of a same chip.

According to an embodiment, the sensor is a fingerprint sensor.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically shows in the form of blocks an embodiment of a microcircuit card communicating with a reader; and

FIG. 2 schematically shows in the form of blocks an example of a functional architecture of the card of FIG. 1.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the data exchanges between the reader and the card as well as the encryption algorithms implemented by the secure microcontroller of the card are not detailed, the described embodiments being compatible with usual data exchanges between a reader and a card and with usual encryption algorithms. Further, the processing of the data originating from the biometric sensor of the card has not been detailed, the embodiments being compatible with usual data processings originating from biometric sensors.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., unless otherwise specified, it is referred to the orientation of the drawings.

Unless specified otherwise, the expressions “around”, “approximately”, “substantially” and “in the order of” signify within 10%, and preferably within 5%.

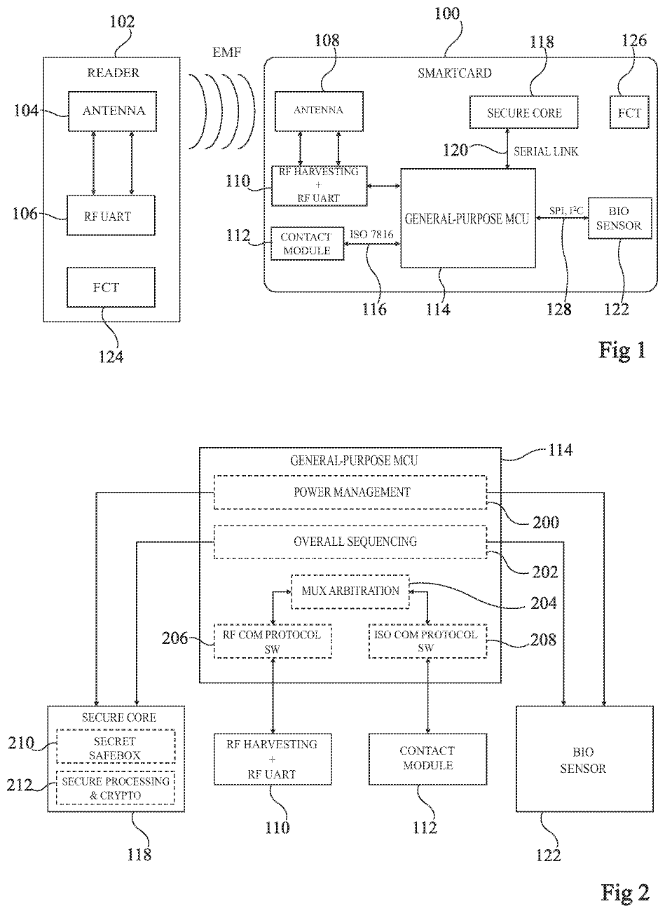

FIG. 1 schematically shows in the form of blocks an embodiment of a microcircuit card 100 (SMARTCARD) communicating with a reader 102 (READER). Card 100, for example, is a contactless bank payment card, a transport card, a personal identification card, etc. Reader 102, for example, is a payment terminal, a transport ticket, a personal access control terminal, etc.

Reader 102 comprises an antenna 104 (ANTENNA). Antenna 104 is, in particular, capable of emitting an electromagnetic field (EMF), for example, a radiofrequency field. In the case of a transmission, the EMF field is, for example, modulated and/or demodulated by an asynchronous transceiver circuit or module 106 (RF UART), for example, a universal asynchronous receiver, of reader 102. In a case where card 100 is located within the range of reader 102, the electromagnetic radiofrequency field EMF modulated by reader 102 may then be captured by an antenna 108 (ANTENNA) of card 100.

FIG. 1 arbitrarily shows the case of a reader 102 comprising a near-field communication module (asynchronous transceiver circuit) 106. This is, however, not limiting. As a variation, reader 102 comprises another communication module, for example, a contact communication module in accordance with standard ISO/IEC 7816. According to the applications, reader 102 thus comprises one or the other of the units, among unit 106 and the contact communication unit (not shown), or both units at the same time.

Card 100 comprises a first circuit or module 110 (RF HARVESTING+RF UART) of communication with the outside of card 100. The first communication module 110 of card 100 is, for example, similar to the module 106 of reader 102. Module 110 is, for example, capable of electrically powering card 100 from the EMF field captured by antenna 108. Although this is not shown, antenna 108 may in practice be coupled to module 110 via a matching circuit.

Card 100 further comprises a second circuit or module 112 (CONTACT MODULE) of communication with the outside of card 100. Second communication module 112 is, for example, a contact communication module. Module 112, for example, enables card 100 to communicate by contact with reader 102, or to communicate with readers similar to reader 102 but comprising no antenna 104 and no near-field communication module 106.

As a variation, card 100 comprises a single communication module among modules 110 and 112, for example contact communication module 112.

According to an embodiment, the communication modules 110 and 112 of card 100 are driven or controlled by a first microcontroller 114 (GENERAL-PURPOSE MCU). The communication modules 110 and 112 of card 100 are, for example, each coupled, preferably connected, to microcontroller 114. In particular, contact communication module 112 is, for example, connected to microcontroller 114 via a link 116 (ISO 7816) in accordance with standard ISO 7816.

Card 100 comprises a second microcontroller 118 (SECURE CORE). Second microcontroller 118 is coupled, preferably connected, to first microcontroller 114 via a serial link 120 (SERIAL LINK).

According to an embodiment, second microcontroller 118 is a secure microcontroller. In particular, microcontroller 118 is dedicated to processing and to storing secure or secret data, that is, data, the access to which is desired to be reserved to certain users or circuits. Microcontroller 118 especially has the function of protecting secret data, for example, data relative to an owner of card 100, and to carry out operations on or by means of the secret data. Microcontroller 118 is, in particular, configured to ascertain that the secret data that it manipulates cannot be discovered by a hacker or pirate.

As an example, second microcontroller 118 has a memory capacity smaller than that of first microcontroller 114. Further, microcontroller 118 is, for example, provided with a computing power smaller than that of microcontroller 114. According to an embodiment, microcontroller 114 is capable of performing more floating point operations per second than microcontroller 118.

According to an embodiment, first microcontroller 114 is configured to drive or control second microcontroller 118. During data exchanges over serial link 120, microcontroller 114 is, for example, configured as a master as long as microcontroller 118 is configured as a slave.

Generally, any communication with the outside of card 100 transits through first microcontroller 114. In particular, second microcontroller 118 can only possibly communicate with the outside of card 100, for example, with reader 102, through first microcontroller 114.

Card 100 further comprises a biometric sensor 122 (BIO SENSOR), for example a fingerprint sensor. Sensor 122 is coupled, preferably connected, to first microcontroller 114 via a link 128 (SPI, I²C), for example, a SPI (Serial Peripheral Interface) serial data bus or an I²C (Inter-Integrated Circuit) bus. First microcontroller 114 is preferably configured to process data originating from biometric sensor 122.

Sensor 122 is not directly coupled to second microcontroller 118. In particular, any possible data exchange, that is, any communication, between sensor 122 and second microcontroller 118 transits through first microcontroller 114. In other words, sensor 122 cannot directly exchange data with second microcontroller 118 without passing through first microcontroller 114 capable of manipulating large quantities of data originating from biometric sensor 122, in particular, data relative to an image filtering in the case of a fingerprint sensor 122.

Generally, first microcontroller 114 is configured to control: second microcontroller 118; communication modules 110 and 112; and biometric sensor 122.

Reader 102 and card 100 may respectively comprise other circuits, for example circuits specific to the application. In FIG. 1, these circuits will be symbolized by a block 124 (FCT), for reader 102, and by a block 126 (FCT), for card 100.

It could also have been devised to provide a card similar to card 100, but for example comprising, instead of microcontrollers 114 and 118, a single microcontroller. It could for example have been devised for the microcontroller to be a secure microcontroller not only enabling to store and to process secret data, but also to perform operations which do not bear on secret data. The microcontroller would for example be used to process data originating from sensor 122 and manage communications with the outside of the card. However, secure microcontrollers are generally more expensive to design, manufacture, and program than microcontrollers which are not capable of manipulating secret data. Accordingly, the use of a single microcontroller to ensure functions similar to those of microcontrollers 114 and 118 together would risk causing an increase in the complexity and the manufacturing cost of the card.

An advantage of card 100 lies in the fact that secure microcontroller 118 is essentially used to process and store secret data. This, for example, advantageously enables to provide the implementation of a secure microcontroller 118 provided with a lower computing power and/or memory capacity than in the case of a card where microcontroller 118 would further be configured to store and/or process non-secure data, for example, data originating from sensor 122 and/or data to be exchanged with communication modules 110 and 112. This further enables a manufacturer of card 100 to integrate microcontroller 118 in one or a plurality of applications without the manufacturer needing (or having) abilities specific to the development of applications executable by secure microcontrollers.

Another advantage of card 100 lies in the fact that the sharing of tasks between microcontroller 114 and secure microcontroller 118 results in a lower complexity and in a greater flexibility in the development of card 100. It is, for example, possible to modify software configured to manage data exchanges with the outside of card 100 without this impacting software executed by microcontroller 118. This, for example, advantageously enables to only have to certify again the software executed by microcontroller 118 in cases, generally uncommon, where modifications bearing on the storage or the processing of secret data have been made.

It could also have been devised to provide a card similar to card 100, but where secure microcontroller 118 would not only enable to store and process secret data, but also to manage communications with the outside of the card. In this case, microcontroller 114 would, for example, be dedicated to the processing of data from sensor 122, and would, in particular, ensure no function of communication with the outside of the card. However, this would require providing a secure microcontroller 118 with a higher performance and/or having a greater memory capacity, and thus generally more expensive, than in the case of card 100. This would further impose more complex certification procedures to the card manufacturer after each modification of the functionalities enabling to manage data exchanges with the outside of the card.

FIG. 2 schematically shows in the form of blocks an example of a functional architecture of the card 100 of FIG. 1.

In the shown example, first microcontroller 14 (GENERAL-PURPOSE MCU) comprises a power management module or unit 200 (POWER MANAGEMENT). Power management unit 200 is, for example, configured to manage the power supply of first microcontroller 114 and/or of at least one element of card 100 (FIG. 1) selected from among second microcontroller 118 (SECURE CORE), communication module 110 (RF HARVESTING+RF UART), communication module 112 (CONTACT MODULE), and biometric sensor 122 (BIO SENSOR). In practice, unit 200, for example, controls an off or on state of at least one switch (not shown), external to microcontroller 114. The switch is capable of cutting off and of restoring the electric power supply of microcontroller 118 and of biometric sensor 122 from module 110. Generally, first microcontroller 114 is preferably configured to manage the electric power supply of second microcontroller 118.

First microcontroller 114 further comprises an operation sequencing module or unit 202 (OVERALL SEQUENCING). Operation sequencing unit 202 is, for example, configured to assign tasks to the different elements of card 100 and/or to manage priorities of execution of the tasks.

In practice, the units 200 and 202 of first microcontroller 114 may be hardware and/or software.

The first microcontroller 114 of card 100 is, for example, configured to implement a near-field communication protocol and a contact communication protocol. In the shown example, microcontroller 114 comprises a multiplexer 204 (MUX ARBITRATION) enabling to selectively activate the execution of near-field communication software 206 (RF COM PROTOCOL SW) or of contact communication software 208 (ISO COM PROTOCOL SW). Software 206, 208 is, for example, configured to drive the associated communication module 110, 112.

In the shown example, second microcontroller 118 comprises a secure memory area 210 (SECRET SAFEBOX). As an example, memory area 210 enables to store secret keys and data, for example, at least one so-called reference fingerprint having data originating from the processing of images acquired by sensor 122 compared therewith.

In the shown example, second microcontroller 118 further comprises a secure processing unit 212 (SECURE PROCESSING & CRYPTO). As an example, unit 212 enables to execute at least one cipher, signature, or authentication algorithm, more generally called cryptographic algorithm.

Although FIGS. 1 and 2 show microcontrollers 114 and 118 with different blocks, microcontrollers 114 and 118 may, in practice, form part of a same chip. As a variant, microcontrollers 114 and 118 are formed inside and on top of different chips.

An advantage of the architecture discussed in relation with FIG. 2 is due to the fact that secure second microcontroller 118 is not involved in the communication(s) with the outside of card 100. This, for example, enables to use a microcontroller 118 provided with an identical hardware and/or software configuration in microcircuit cards 100 aiming at different applications.

Various embodiments and variants have been described. Those skilled in the art will understand that certain features of these various embodiments and variants may be combined, and other variants will occur to those skilled in the art. In particular, it will be within the abilities of those skilled in the art to adapt the described embodiments to a microcircuit card 100 comprising a single communication module.

Finally, the practical implementation of the described embodiments and variants is within the abilities of those skilled in the art based on the functional indications given hereabove. In particular, the practical implementation of communication modules 110 and 112, of microcontrollers 114 and 118, as well as of biometric sensor 122, is within the abilities of those skilled in the art based on the above indications.

It will further be within the abilities of those skilled in the art, based on the indications provided hereabove, to adapt the features of the radiofrequency communication according to the targeted application. In particular, it will be within the abilities of those skilled in the art to adapt the above embodiments to comply with the requirements of standard ISO 14443 of the banking sector.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A microcircuit card, comprising:
a first microcontroller;
a second microcontroller;
at least one module of communication with the outside of the card; and
a biometric sensor,
wherein:
any communication by the card to an outside of the card transits through the first microcontroller;
any communication between the biometric sensor and the second microcontroller transits through the first microcontroller; and
the second microcontroller is not involved in any communication to the outside of the card.

2. The card according to claim 1, wherein the second microcontroller is a secure microcontroller.

3. The card according to claim 1, wherein the second microcontroller is dedicated to processing and storing secure data.

4. The card according to claim 1, wherein the second microcontroller has a memory capacity smaller than that of the first microcontroller.

5. The card according to claim 1, wherein said at least one module of communication comprises a first near-field communication module and a second contact communication module, and wherein the first microcontroller is coupled for communication to both the first near-field communication module and the second contact communication module.

6. The card according to claim 5, wherein the first microcontroller is configured to implement: a near-field communication protocol through the first near-field communication module; and a contact communication protocol through the second contact communication module.

7. The card according to claim 1, wherein the first microcontroller comprises: a power management unit; and an operation sequencing unit.

8. The card according to claim 1, wherein the first microcontroller is configured to control operations performed by: the second microcontroller; the at least one module of communication; and the biometric sensor.

9. The card according to claim 1, wherein the first microcontroller is configured to manage an electric power supply of the second microcontroller.

10. The card according to claim 1, wherein the first microcontroller is configured to process data originating from the biometric sensor.

11. The card according to claim 1, wherein the first microcontroller and the second microcontroller form part of a same chip.

12. The card according to claim 1, wherein the biometric sensor is a fingerprint sensor.

13. A microcircuit card, comprising:
a general purpose microcontroller;
a secure processing microcontroller configured to process and store secure or secret data;
a first communications link between the general purpose microcontroller and the secure processing microcontroller, wherein said first communications link to the general purpose microcontroller provides the sole communications connection for the secure processing microcontroller to communicate outside of the secure processing microcontroller;
at least one module of communication with the outside of the card, wherein said general purpose microcontroller is configured to control communications through said least one module of communication;
a second communications link between the general purpose microcontroller and the at least one module of communication;
a biometric sensor; and
a third communications link between the general purpose microcontroller and the biometric sensor, wherein said general purpose microcontroller is further configured to control passage of biometric data from the biometric sensor to the secure processing microcontroller through the general purpose microcontroller and over the first and third communications links.

14. The card according to claim 13, wherein the secure processing microcontroller does not engage in any communication to the outside of the card.

15. The card according to claim 13, wherein the secure processing microcontroller has a memory capacity smaller than that of the general purpose microcontroller.

16. The card according to claim 13, wherein said at least one module of communication comprises a first near-field communication module and a second contact communication module, and wherein the general purpose microcontroller is coupled for communication to both the first near-field communication module and the second contact communication module.

17. The card according to claim 16, wherein the general purpose microcontroller is configured to implement: a near-field communication protocol through the first near-field communication module; and a contact communication protocol through the second contact communication module.

18. The card according to claim 13, wherein the general purpose microcontroller is configured to control operations performed by: the secure processing microcontroller; the at least one module of communication; and the biometric sensor.

19. The card according to claim 13, wherein the biometric sensor is a fingerprint sensor.
